(19) United States
(12) Patent Application Publication
(10) Pub. No.: US 2026/0223206 A1
(43) Pub. Date: Jul. 30, 2026

(54) PROGRAMMABLE PROTOCOL-INDEPENDENT SESSION PROCESSOR (PPSP) -BASED COMMUNICATION SYSTEM

(71) Applicant: Level 3 Communications, LLC, Denver, CO (US)

(72) Inventor: Adam UZELAC, Rochester, NY (US)

(73) Assignee: Level 3 Communications, LLC, Denver, CO (US)

(21) Appl. No.: 19/395,206

(22) Filed: Nov. 20, 2025

Related U.S. Application Data
(60) Provisional application No. 63/751,633, filed on Jan. 30, 2025.

(51) Int. Cl. H04W 76/10; H04W 24/08; H04W 40/22

(52) U.S. Cl. CPC H04W 76/10; H04W 24/08; H04W 40/22

(57) ABSTRACT

Novel tools and techniques are provided for implementing programmable protocol-independent session processor (“PPSP”)-based communications. When a computing system determines that a first administrative domain and a second administrative domain require different signaling protocols to establish communication sessions for user devices in the two administrative domains, the computing system may convert one or more signaling protocols used by the two administrative domains into a common signaling protocol, and may establish an end-to-end (“E2E”) real-time communication session between the user devices in the two administrative domains, using the common signaling protocol. The computing system may manage the E2E real-time communication session across control and data planes of session processing devices in the two administrative domains, may monitor E2E session metrics across the E2E real-time communication session, and may provide each session processing device with access to the E2E session metrics, as well as access to other E2E session features.

### CROSS-REFERENCE TO RELATED APPLICATIONS

This application claims the benefit of U.S. Provisional Application No. 63/751,633 filed Jan. 30, 2025, entitled “Programmable Protocol-Independent Session Processor (PPSP)-Based Communication System,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing programmable protocol-independent session processor (“PPSP”)-based communications.

### BACKGROUND

For establishing communication sessions across multiple administrative domains, particularly where the administrative domains utilize disparate signaling protocols and corresponding network infrastructure, conventional systems essential hand-off portions of the communication session from one administrative domain to another. Due to the siloed manner in which each administrative domain handles the communication request and the subsequent communication session, it is not possible for such existing systems to have an end-to-end (“E2E”) view of the entire communication session. This can lead to potential gaps in session security as well as issues with session quality of service (“QoS”), interoperability, and/or extensibility. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing PPSP-based communications, in accordance with various embodiments.

FIGS. 2A-2C depict example sets of interactions among system components for implementing PPSP-based communications, in accordance with various embodiments.

FIGS. 3A-3F depict flow diagrams illustrating an example method for implementing PPSP-based communications, in accordance with various embodiments.

FIGS. 4A and 4B depict flow diagrams illustrating another example method for implementing PPSP-based communications, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

Presently, to establish communication sessions across multiple administrative domains, particularly where the administrative domains utilize disparate signaling protocols and corresponding network infrastructure, conventional systems either have stitch together (or hand-off) siloed portions of communication sessions or have to invite the parties to the communication session to a single walled garden (which is not always possible, feasible, or available). Due to the siloed manner in which each administrative domain handles the communication request and the subsequent communication session, it is not possible for such existing systems to have an E2E view of the entire communication session. This can lead to potential gaps in session security as well as issues with session QoS, interoperability, and/or extensibility. It is also not possible to provide compliance monitoring (and enforcement) across the disparate administrative domains.

The present technology provides for PPSP-based communications that enables E2E real-time communications across disparate administrative domains. The PPSP-based communications system is protocol-independent, enabling abstraction from underlying signaling protocols (e.g., SIP, WebRTC, XMPP, etc.) while ensuring interoperability and extensibility. Unlike packet-focused approaches, the PPSP-based communications system operates at the session level, managing session lifecycle, signaling, state, and interdependencies across multiple modalities (e.g., voice, video, data). The PPSP-based communications system enables E2E session monitoring and provides each session processing device in a corresponding administrative domain among the disparate multiple administrative domains with access to E2E session metrics obtained during the E2E session monitoring, which is not possible with conventional systems. In this manner, each session processing device (i.e., each administrative domain) has a transparent view of the operations and telemetry for communication sessions that are established across the corresponding administrative domain's network infrastructure. Further, the PPSP-based communications system enables E2E compliance monitoring, which, in some cases, enables a more secure communication session across all portions (or legs) of the communication session, while enabling enforcement of compliance requirements across the E2E real-time communication session.

These and other aspects of the PPSP-based communications are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: receiving, by a computing system in a central administrative domain and from a first session processing device in a first administrative domain, a request to establish a communication session between a first user device in the first administrative domain and a second user device in a second administrative domain; identifying, by the computing system, a signaling protocol that is used by each of the first administrative domain and the second administrative domain to establish communication sessions; based on a determination that the first administrative domain and the second administrative domain require different signaling protocols to establish communication sessions, performing the following: converting, by the computing system, at least one of a first signaling protocol used by the first administrative domain or a second signaling protocol used by the second administrative domain into a common signaling protocol; establishing, by the computing system, an E2E real-time communication session between the first user device in the first administrative domain and the second user device in the second administrative domain, using the common signaling protocol; managing, by the computing system, the E2E real-time communication session across control and data planes of the first session processing device in the first administrative domain and a second session processing device in the second administrative domain; monitoring, by the computing system, E2E session metrics across the E2E real-time communication session between the first user device and the second user device, and across the control and data planes of the first session processing device and the second session processing device; providing, by the computing system, each of the first session processing device and the second session processing device with access to the E2E session metrics and reports generated based on the E2E session metrics; and in response to receiving a termination request from one of the first user device or the second user device, terminating, by the computing system, the E2E real-time communication session, and causing, by the computing system, release of resources that are used to establish and maintain the E2E real-time communication session.

In another aspect, the technology relates to a PPSP-based communications system, including a computing system in a central administrative domain, and memory coupled to the computing system. The memory may include computer executable instructions that, when executed by the computing system, may cause the PPSP-based communications system to perform operations including: receiving, from a first session processing device in a first administrative domain, a request to establish a communication session between a first user device in the first administrative domain and a second user device in a second administrative domain; identifying a signaling protocol that is used by each of the first administrative domain and the second administrative domain to establish communication sessions; based on a determination that the first administrative domain and the second administrative domain require different signaling protocols to establish communication sessions, performing the following: converting at least one of a first signaling protocol used by the first administrative domain or a second signaling protocol used by the second administrative domain into a common signaling protocol; establishing an E2E real-time communication session between the first user device in the first administrative domain and the second user device in the second administrative domain, using the common signaling protocol; managing the E2E real-time communication session across control and data planes of the first session processing device in the first administrative domain and a second session processing device in the second administrative domain; monitoring E2E session metrics across the E2E real-time communication session between the first user device and the second user device, and across the control and data planes of the first session processing device and the second session processing device; providing each of the first session processing device and the second session processing device with access to the E2E session metrics and reports generated based on the E2E session metrics; and in response to receiving a termination request from one of the first user device or the second user device, terminating the E2E real-time communication session, and causing release of resources that are used to establish and maintain the E2E real-time communication session.

In yet another aspect, the technology relates to a method, including: receiving, by a computing system in a central administrative domain and from a first session processing device in a first administrative domain, a request to establish a communication session between a first user device in the first administrative domain and each of a second user device in a second administrative domain and a third user device in a third administrative domain; identifying, by the computing system, a signaling protocol that is used by each of the first administrative domain, the second administrative domain, and the third administrative domain to establish communication sessions; based on a determination that at least two of the first administrative domain, the second administrative domain, and the third administrative domain require different signaling protocols to establish communication sessions, performing the following: converting, by the computing system, at least one of a first signaling protocol used by the first administrative domain, a second signaling protocol used by the second administrative domain, or a third signaling protocol used by the third administrative domain into a common signaling protocol; establishing, by the computing system, an E2E real-time communication session among the first user device in the first administrative domain, the second user device in the second administrative domain, and the third user device in the third administrative domain, using the common signaling protocol; managing, by the computing system, the E2E real-time communication session across control and data planes of the first session processing device in the first administrative domain, a second session processing device in the second administrative domain, and a third session processing device in the third administrative domain; monitoring, by the computing system, E2E session metrics across the E2E real-time communication session among the first user device, the second user device, and the third user device, and across the control and data planes of the first session processing device, the second session processing device, and the third session processing device; providing, by the computing system, each of the first session processing device, the second session processing device, and the third session processing device with access to the E2E session metrics and reports generated based on the E2E session metrics; and in response to receiving a termination request from one of the first user device, the second user device, or the third user device, terminating, by the computing system, the E2E real-time communication session, and causing, by the computing system, release of resources that are used to establish and maintain the E2E real-time communication session.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

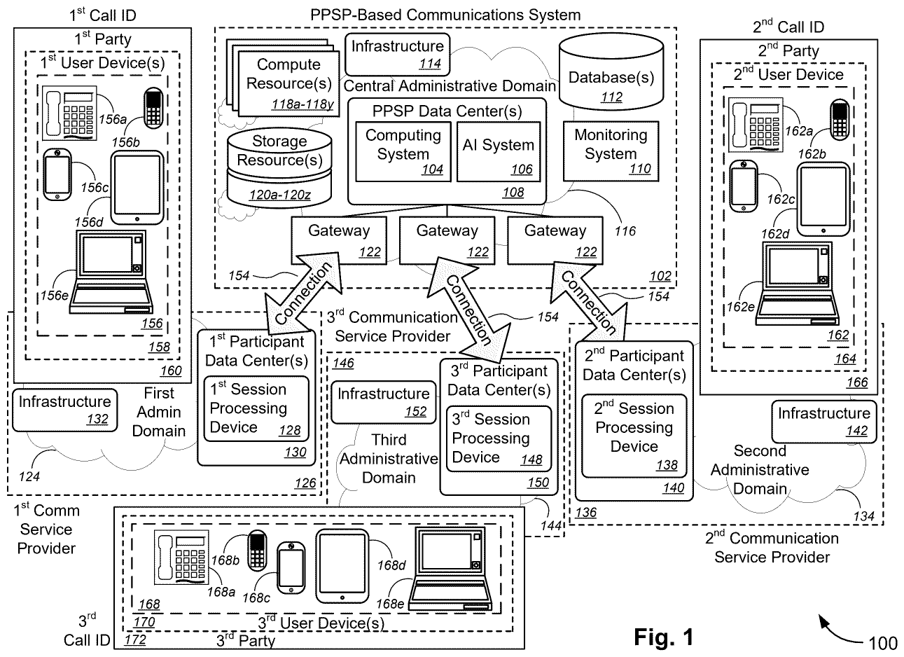

Turning to the embodiments as illustrated by the drawings, FIGS. 1-5 illustrate some of the features of methods, systems, and apparatuses for implementing PPSP-based communications, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing PPSP-based communications, in accordance with various embodiments.

In the non-limiting embodiment of FIG. 1, system 100 may include a PPSP-based communications system 102, which may include a computing system 104 and an artificial intelligence (“AI”) system 106 that are located within a PPSP data center(s) 108. In some examples, the PPSP-based communications system 102 may further include a monitoring system 110, a database(s) 112, and network infrastructure 114. In examples, the computing system 104, the AI system 106, the monitoring system 110, the database(s) 112, and/or the network infrastructure 114 may be part of or located within a central administrative domain 116. In some examples, the PPSP-based communications system 102 may further include a plurality of compute resource(s) 118a-118y, a plurality of storage resource(s) 120a-120z, and a plurality of gateway devices 122. Herein, y and z are non-negative integer numbers that may be either all the same as each other, all different from each other, or some combination of same and different (e.g., one set of two or more having the same values with the others having different values, a plurality of sets of two or more having the same value with the others having different values, etc.).

In some examples, system 100 may further include a first administrative domain 124 that is associated with a first communication service provider 126. System 100 may further include a first session processing device 128, a first participant data center(s) 130, and network infrastructure 132 that are each also associated with the first communication service provider 126. In some cases, the first session processing device 128 is located within the first participant data center(s) 130. Similarly, system 100 may further include a second administrative domain 134 that is associated with a second communication service provider 136. System 100 may further include a second session processing device 138, a second participant data center(s) 140, and network infrastructure 142 that are each also associated with the second communication service provider 136. In some cases, the second session processing device 138 is located within the second participant data center(s) 140. Likewise, system 100 may further include a third administrative domain 144 that is associated with a third communication service provider 146. System 100 may further include a third session processing device 148, a third participant data center(s) 150, and network infrastructure 152 that are each also associated with the third communication service provider 146. In some cases, the third session processing device 148 is located within the third participant data center(s) 150. In examples, the first administrative domain 124, the first session processing device 128, and/or the first participant data center(s) 130 communicatively couples with one of the gateway devices 122 of the PPSP-based communications system 102 and/or of central administrative domain 116 via connection 154. Similarly, the second administrative domain 134, the second session processing device 138, and/or the second participant data center(s) 140 communicatively couples with another one of the gateway devices 122 of the PPSP-based communications system 102 and/or of central administrative domain 116 via connection 154. Likewise, the third administrative domain 144, the third session processing device 148, and/or the third participant data center(s) 150 communicatively couples with yet another one of the gateway devices 122 of the PPSP-based communications system 102 and/or of central administrative domain 116 via connection 154. In some examples, each connection 154 is a high-speed network connections 154 between one of the gateway devices 122 and a participant data center (e.g., first, second, or third participant data center(s) 130, 140, or 150). In some examples, the high-speed network connections 154 may include optical fiber connections, free-space optical connections, and/or the like.

In some examples, the computing system 104 may include at least one of a programmable protocol-independent session processor, a system orchestrator, a server, a cloud computing system, or a distributed computing system. In examples, the programmable protocol-independent session processor may be configured to decouple a session logic of communication sessions from signaling protocols used by the first administrative domain 124, the second administrative domain 134, and the third administrative domain 144. In some instances, the programmable protocol-independent session processor may be further configured to perform session initiation, session negotiation, session routing, session quality control, session termination, and session state management across multiple domains using different signaling protocols, or the like. In examples, the AI system 106 may be used to optimize call sessions and/or to provide extensibility functions that facilitates extensions for new signaling protocols, media types, and/or application-layer enhancements, and/or the like. In some examples, the first session processing device 128, the second session processing device 138, and the third session processing device 148 may each be a programmable session processing device including one of a software switch, a gateway device, a session border controller (“SBC”), or a communication platform, and/or the like. In examples, the first administrative domain 124, the second administrative domain 134, and the third administrative domain 144 may utilize a corresponding one of a first signaling protocol, a second signaling protocol, and a third signaling protocol to establish communication sessions. A signaling protocol, as used herein, may refer to a type of communications protocol that encapsulates signaling between communication endpoints and switching systems to establish or terminate a connection and to identify the state of the connection. In an example, the first signaling protocol, the second signaling protocol, and the third signaling protocol may be the same signaling protocol. In another example, two of the first signaling protocol, the second signaling protocol, and the third signaling protocol are the same signaling protocol, while the remaining signaling protocol is a different signaling protocol. In yet another example, each of the first signaling protocol, the second signaling protocol, and the third signaling protocol is different from the other signaling protocols. In some examples, the first signaling protocol, the second signaling protocol, and the third signaling protocol may include one of a session initiation protocol (“SIP”), a web real-time communications (“WebRTC”) protocol, an extensible messaging and presence protocol (“XMPP”), a Signaling System No. 7 (“SS7”) protocol, a media gateway control protocol (“MGCP”), a Q.931 protocol, a H.323 protocol, or a Q-Signaling (“QSIG”) protocol, and/or the like.

An administrative domain, as used herein, may refer to a network environment in which credentials enable facilitated authentication and authorization of clients within the network environment. The administrative domain may be implemented as a collection of hosts, routers, and/or interconnecting networks that are managed by a single administrative authority (in this case, a service provider providing PPSP-based communication services via the PPSP-based communications system 102, the first communications service provider 126, the second communications service provider 136, or the third communications service provider 146, or the like). In examples, the first communications service provider 126, the second communications service provider 136, and the third communications service provider 146 may each include at least one of a communication service infrastructure provider (also referred to as a “hyperscaler,” “hyperscale company,” or “hyperscale cloud service provider”), a unified communications and collaboration (“UC&C”) provider, a contact center software provider, a voice over Internet protocol (“VoIP”) provider, or a consumer communication application provider, and/or the like.

A hyperscaler, as used herein, may refer to an entity or service provider that performs at least one of consulting, designing, developing, building, managing, and/or orchestrating software, data, and/or applications to rapidly and efficiently scale compute resources, storage resources, and/or network resources by adding or assigning (or re-assigning) resources such as servers and storage systems, or the like. Examples of hyperscalers may include Amazon AWS®, Microsoft Azure®, Google GCP®, IBM®, Oracle®, Apple®, Meta®, etc. In some examples, where the first, second, and third communication service providers 126, 136, and 146 are hyperscalers, the first, second, and third participant data centers 130, 140, and 150 may each include at least one of servers, switches, routers, firewalls, storage systems, security systems, cables, and/or connectors, and/or the like, while the corresponding infrastructure 132, 142, and 152 may each include one or more of the respective data centers 130, 140, and 150 and their components, database management systems, machine learning systems, data analytics systems, virtualization systems (including hypervisors, virtual machines (“VMs”), containers, and/or the like), distributed computing systems, edge computing systems, load balancing systems, and/or the like.

A UC&C provider, as used herein, may refer to an entity or service provider that provides or provisions, to users, a single interface that combines unified communications tools for real-time and non-real-time collaboration. In examples, the unified communications tools may include a combination of two or more of a voice service platform, an Internet Protocol (“IP”) telephony calling (or VoIP) platform, an email platform, an instant messaging or chat platform, a collaboration facilitator platform (including scheduling platform, project/user management platform, screen sharing platform, file sharing platform, online/offline presence monitoring platform, etc.), a web conferencing platform, an audio conferencing platform, or a video conferencing platform, and/or the like. In some instances, the unified communications tools may include both cloud-based and premises-based systems. Examples of UC&C providers may include Cisco Webex®, 8x8®, RingCentral®, Microsoft Teams®, Zoom®, etc. UC&C providers, in some cases, may utilize data centers and/or infrastructure of hyperscalers. That is, in some cases, the data centers and/or infrastructure of hyperscalers may host applications and/or platforms of the UC&C providers.

A contact center software provider, as used herein, may refer to an entity or service provider that provides contact center software, which is a collection of applications that automate key contact center processes including at least one of routing inbound calls, routing outbound calls, collecting caller information, triggering prerecorded answers to frequently asked questions, initiating interactive voice response (“IVR”) systems, transferring callers to other channels, routing inbound email messages, routing inbound chat message communications, implementing call monitoring and analytics, implementing message monitoring and analytics, and/or the like. Contact center software assists organizations in controlling costs, developing agents, monitoring and enhancing customer experience, maintaining compliance with laws and regulations, and/or the like. In examples, contact center software may be hosted on-site (sometimes referred to as “on-premises”) or hosted by a vendor in the cloud in a software as a service (“SaaS”) arrangement. For the latter case, in some examples, contact center software providers may utilize data centers and/or infrastructure of hyperscalers. That is, in some cases, the data centers and/or infrastructure of hyperscalers may host applications and/or platforms of the contact center software providers. In some examples, the data centers and/or infrastructure of hyperscalers may include one or more IP switches that are tied to a contact center software provider.

A VoIP provider, as used herein, may refer to an entity or service provider that offers VoIP services directly to consumers or businesses. VoIP technology enables use of IP networks to perform telephony functions, such as making and receiving phone calls. In examples, VoIP providers may include cloud-based PBX providers. In some examples, VOIP providers may utilize data centers and/or infrastructure of hyperscalers. That is, in some cases, the data centers and/or infrastructure of hyperscalers may host applications and/or platforms of the VOIP providers. In some examples, the data centers and/or infrastructure of hyperscalers may include one or more IP switches that are tied to a VoIP provider.

A consumer communication application provider, as used herein, may refer to an entity or service provider that enables live communication via communication applications including messaging applications, audio and video calling applications, and/or the like. Some of these communication applications enable multiple modes of live communication. In some examples, consumer communication application providers may utilize data centers and/or infrastructure of hyperscalers. That is, in some cases, the data centers and/or infrastructure of hyperscalers may host applications and/or platforms of the consumer communication application providers.

According to some embodiments, unless otherwise indicated, networks 116, 124, 134, and 144 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 116, 124, 134, and 144 may include an access network of the service provider (e.g., an Internet service provider (“ISP”)). In another embodiment, the networks 116, 124, 134, and 144 may include a core network of the service provider and/or the Internet.

In some examples, system 100 may further include a first user device(s) 156 that is associated with a first party 158 (also referred to herein as “originating party 158,” “calling party 158,” or “first user 158,” or the like) at a first address or call identifier (“ID”) 160 (also referred to as “source address 160” or the like) in an originating network(s) (in this case, first administrative domain 124, or the like). In some instances, the first user device(s) 156 may include, but is not limited to, at least one of a telephone 156a, a mobile phone 156b, a smart phone 156c, a tablet computer 156d, a laptop computer 156e, or other device (e.g., a desktop computer, etc.), and/or the like. System 100 likewise may further include a second user device(s) 162 that is associated with a second party 164 (also referred to as “terminating party 164,” “called party 164,” or “second user 164,” or the like) at a second address or call ID 166 (also referred to as “terminating address 166” or the like) in a terminating network(s) (in this case, second administrative domain 134, or the like). In some instances, the second user device(s) 162, similar to user device(s) 156, may include, but is not limited to, at least one of a telephone 162a, a mobile phone 162b, a smart phone 162c, a tablet computer 162d, a laptop computer 162e, or other device (e.g., a desktop computer, etc.), and/or the like. Similarly, system 100 may further include a third user device(s) 168 that is associated with a third party 170 (also referred to as “terminating party 170,” “called party 170,” or “third users 170,” or the like) at a third address or call ID 172 (also referred to as “terminating address 172” or the like) in a terminating network(s) (in this case, third administrative domain 144, or the like). In some instances, the third user device(s) 168, similar to user devices 156 and 162, may include, but is not limited to, at least one of a telephone 168a, a mobile phone 168b, a smart phone 168c, a tablet computer 168d, a laptop computer 168e, or other device (e.g., a desktop computer, etc.), and/or the like.

In examples, the call IDs 160, 166, and 172 may each include one of a telephone number associated with a particular user, a unique user ID that is associated with the particular user for call connection purposes, or a unique network ID that is associated with the particular user for call connection purposes, and/or the like. In some cases, the first party 158, the second party 164, and the third party 170 may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

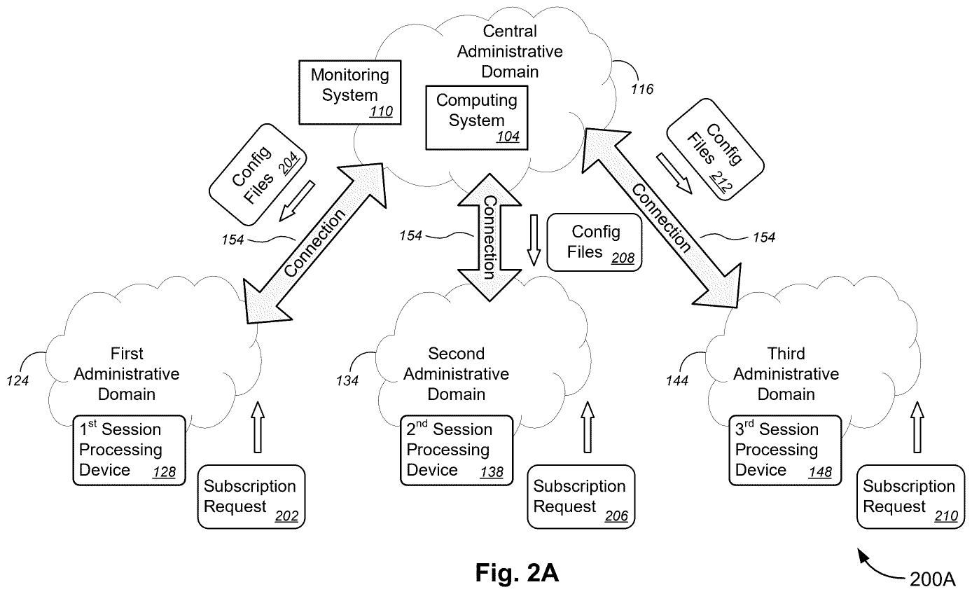

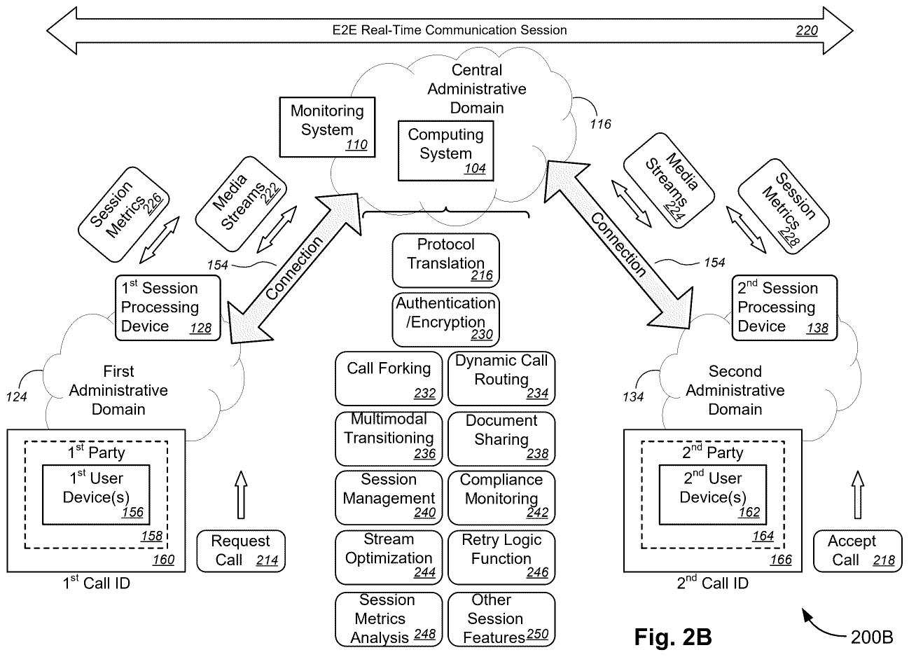

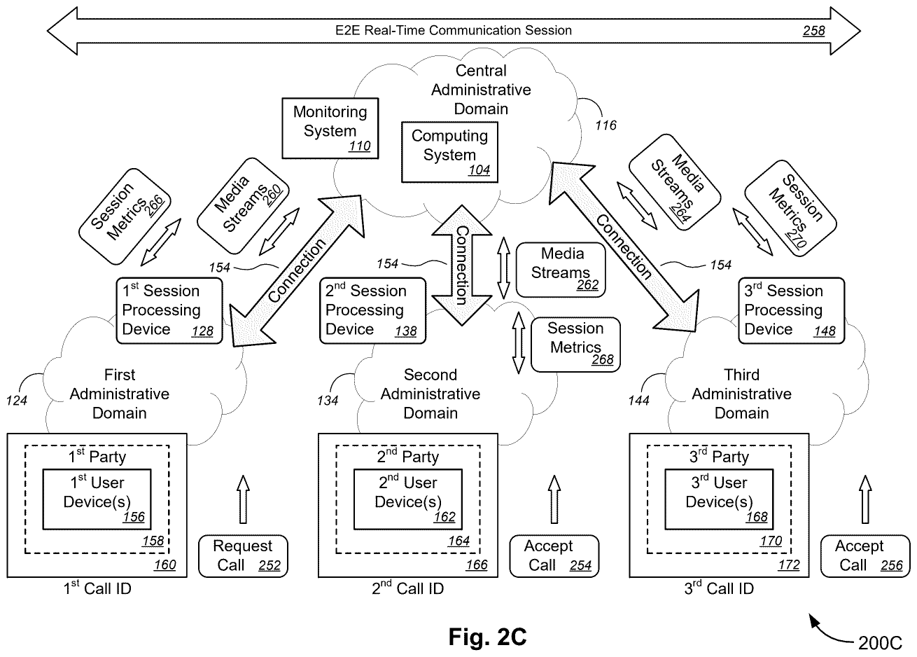

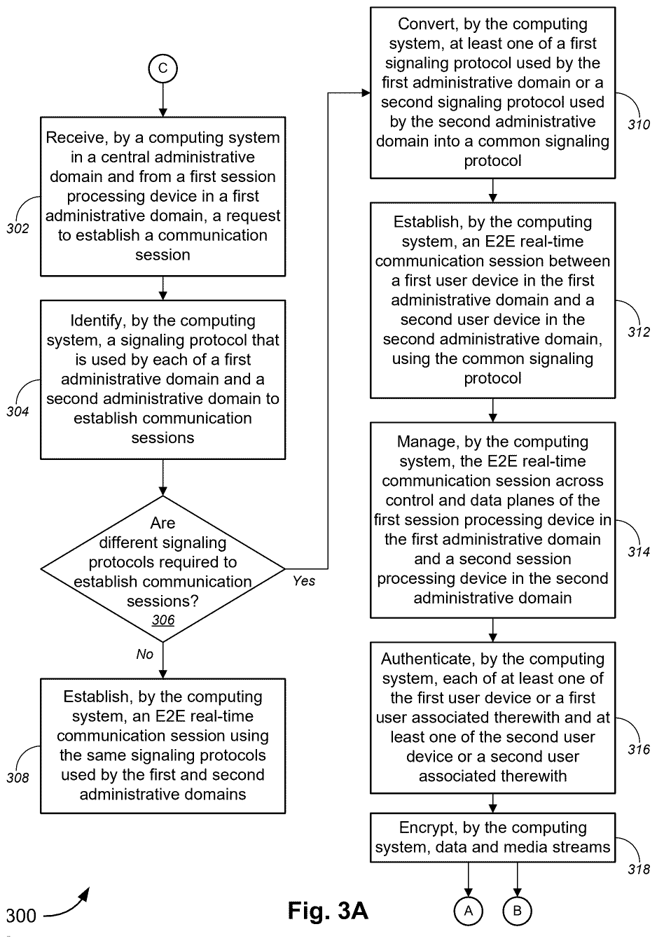

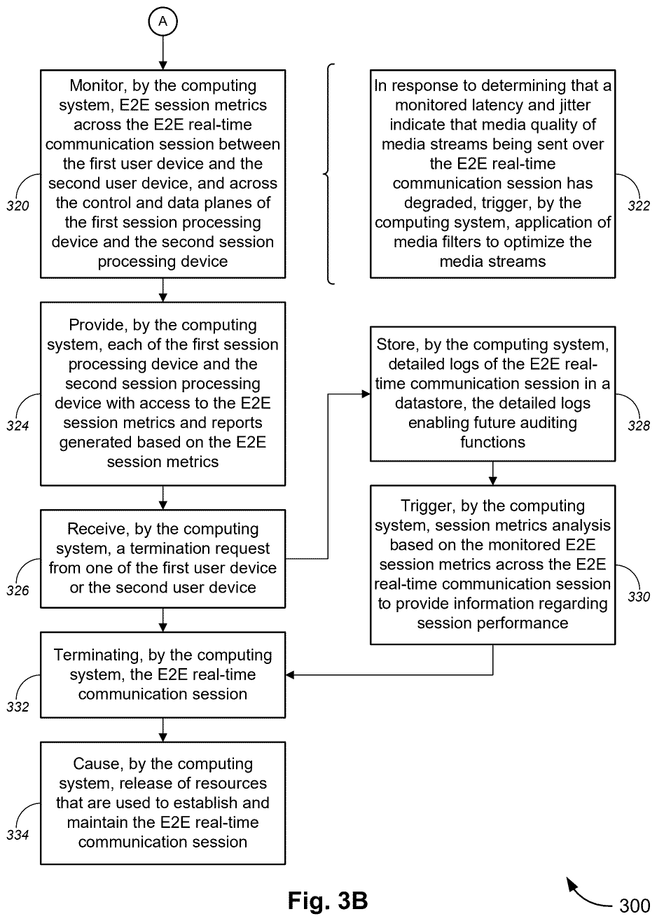

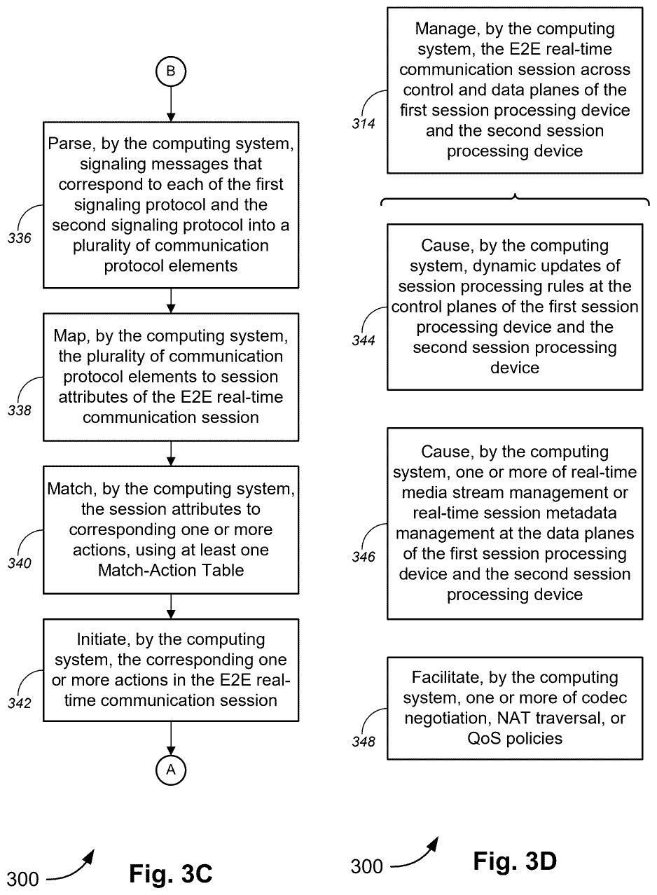

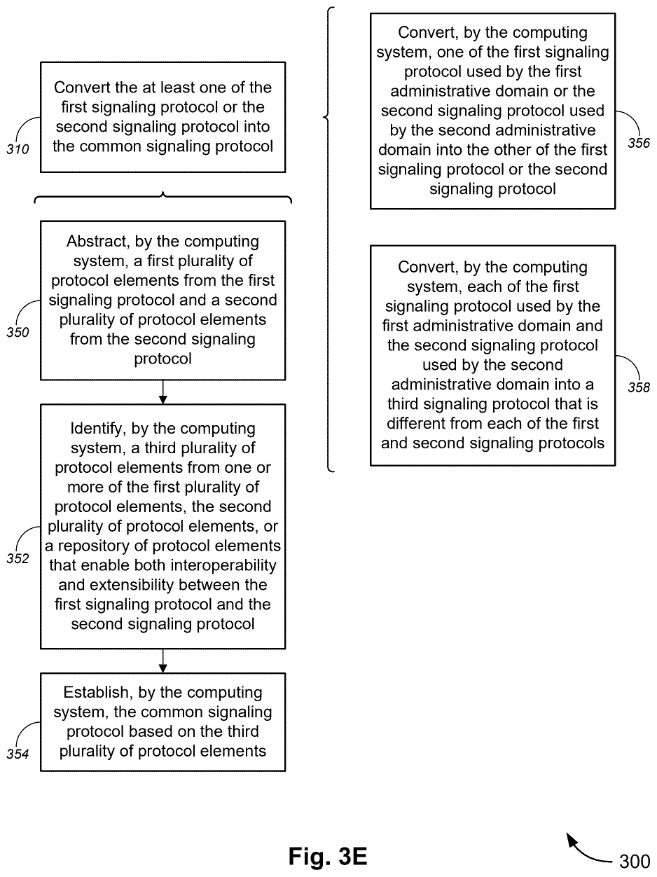

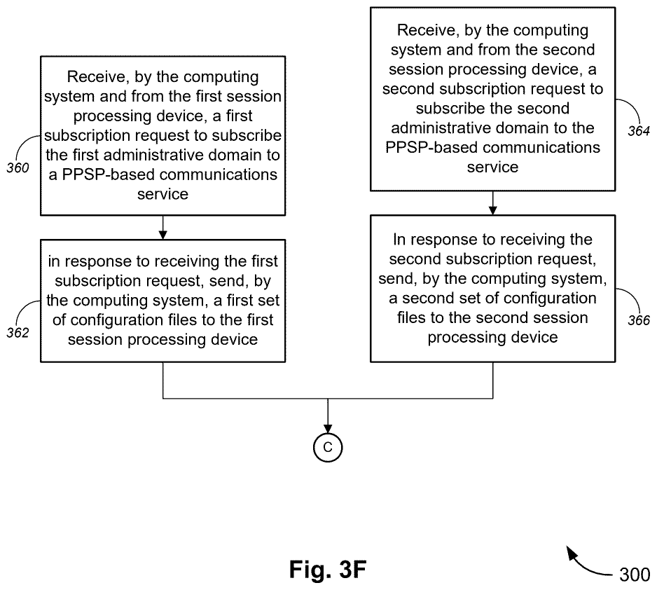

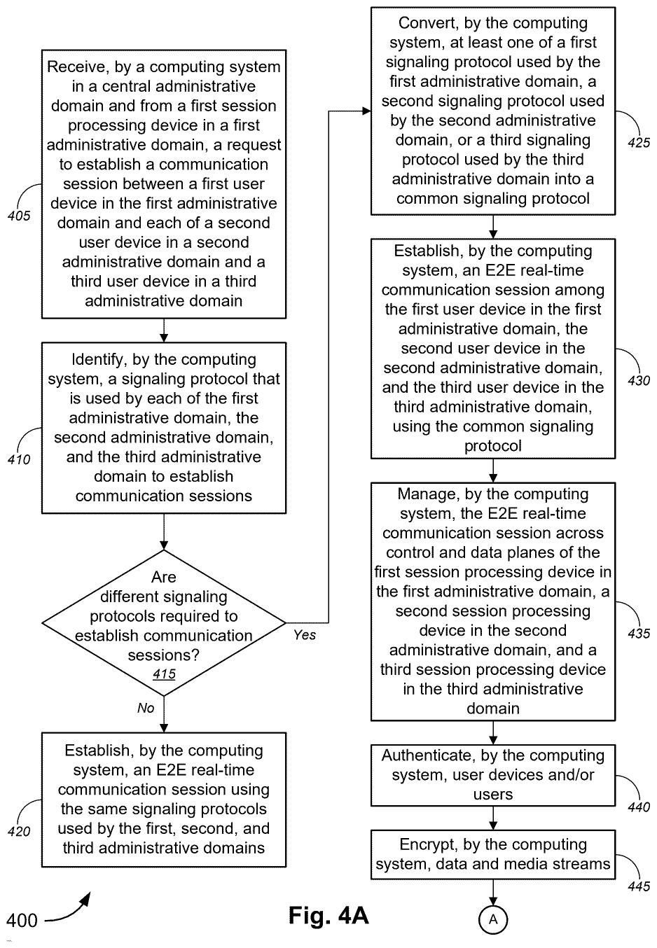

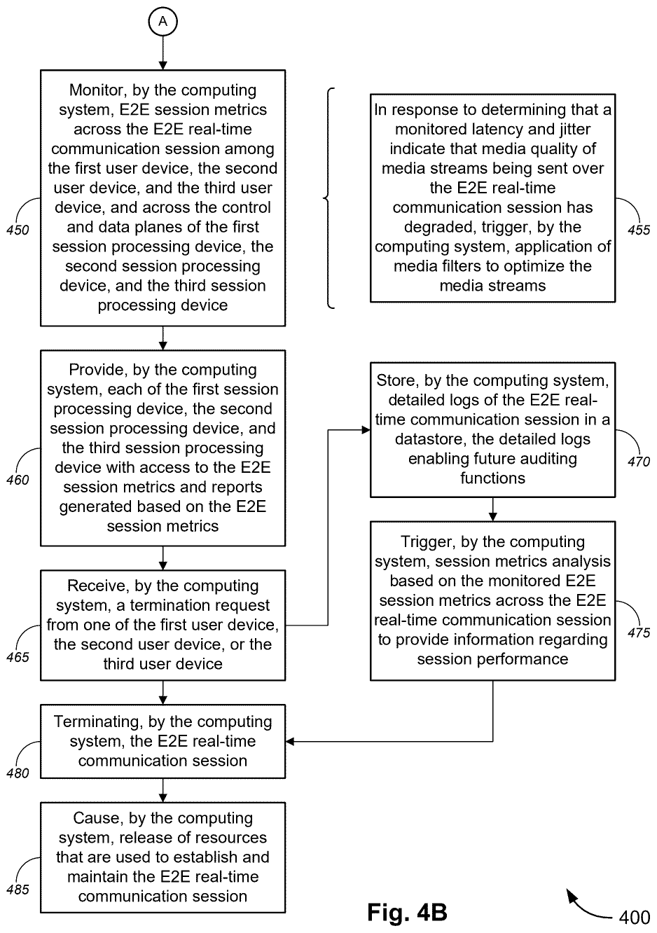

In operation, PPSP-based communications system 102 and/or computing system 104 may perform methods for implementing PPSP-based communications, as described in detail with respect to FIGS. 2A-4B. For example, example sets 200A, 200B, and 200C of interactions among system components as described below with respect to FIGS. 2A, 2B, and 2C, and methods 300 and 400 as described in detail with respect to FIGS. 3A-3F and 4A-4B may be applied with respect to the operations of system 100 of FIG. 1.

FIGS. 2A-2C (collectively, “FIG. 2”) depict example sets 200A, 200B, and 200C of interactions among system components for implementing PPSP-based communications, in accordance with various embodiments. FIG. 2A is directed to configuration of two or more administrative domains to enable PPSP-based E2E real-time communications with other administrative domains among the two or more administrative domains. FIG. 2B is directed to establishing E2E real-time communications between two parties in different administrative domains requiring different signaling protocols to establish communications. FIG. 2C is directed to establishing E2E real-time communications among three parties in different administrative domains requiring different signaling protocols to establish communications. Although two device implementation (as described with respect to example set 200B of interactions of FIG. 2B) and three device implementation (as described with respect to example set 200C of interactions of FIG. 2C) are described herein, the various embodiments are not so limited, and any suitable number of devices in any suitable number of different (or same) administrative domains may be connected using the E2E real-time communication session as described herein, albeit adapted for the number of devices connected.

In some embodiments, computing system 104, monitoring system 110, central administrative domain 116, first administrative domain 124, first session processing device 128, second administrative domain 134, second session processing device 138, third administrative domain 144, third session processing device 148, connections 154, first user device(s) 156, first party 158, first call ID 160, second user device(s) 162, second party 164, second call ID 166, third user device(s) 168, third party 170, and third call ID 172 of FIGS. 2A-2C may be similar, if not identical, to the computing system 104, monitoring system 110, central administrative domain 116, first administrative domain 124, first session processing device 128, second administrative domain 134, second session processing device 138, third administrative domain 144, third session processing device 148, connections 154, first user device(s) 156 and 156a-156e, first party 158, first call ID 160, second user device(s) 162 and 162a-162e, second party 164, second call ID 166, third user device(s) 168 and 168a-168e, third party 170, and third call ID 172, respectively, of system 100 of FIG. 1, and the description of these components of system 100 of FIG. 1 are similarly applicable to the corresponding components of FIGS. 2A-2C.

With reference to FIG. 2A, prior to receiving requests to establish E2E communications, first session processing device 128 in first administrative domain 124 may send a subscription request 202 to computing system 104 in central administrative domain 116, over connection 154. After receiving the subscription request 202, the computing system 104 may send a first set of configuration files 204 to the first session processing device 128, over connection 154. In examples, the first set of configuration files 204 may cause a configuration change in the first session processing device 128 that enables a secure line of communication between the computing system 104 in the central administrative domain 116 and the first session processing device 128 in the first administrative domain 124.

Similarly, second session processing device 138 in second administrative domain 134 may send a subscription request 206 to computing system 104 in central administrative domain 116, over connection 154. After receiving the subscription request 206, the computing system 104 may send a second set of configuration files 208 to the second session processing device 138, over connection 154. In examples, the second set of configuration files 208 may cause a configuration change in the second session processing device 138 that enables a secure line of communication between the computing system 104 in the central administrative domain 116 and the second session processing device 138 in the second administrative domain 134.

Likewise, third session processing device 148 in third administrative domain 144 may send a subscription request 210 to computing system 104 in central administrative domain 116, over connection 154. After receiving the subscription request 210, the computing system 104 may send a third set of configuration files 212 to the third session processing device 148, over connection 154. In examples, the third set of configuration files 212 may cause a configuration change in the third session processing device 148 that enables a secure line of communication between the computing system 104 in the central administrative domain 116 and the third session processing device 148 in the third administrative domain 144.

The secure line of communication between the computing system 104 and each of the session processing devices in their corresponding administrative domains enable establishment of E2E real-time communication sessions among the session processing devices in the corresponding administrative domains even when one or more of the administrative domains use different signaling protocols for establishing call connections. Other features of the PPSP-based communications (as described below) may also be enabled by the secure line of communication and/or the configuration change in the session processing devices.

Referring to FIG. 2B, a first user device(s) 156, which is associated with first party 158 and with first call ID 160, may send a request 214 to establish a communication session between the first user device 156 in the first administrative domain 124 and a second user device(s) 162 in second administrative domain 134. In examples, the second user device(s) 162 may be associated with second party 164 and with second call ID 166. In response to receiving the request 214 from the first user device(s) 156, the first session processing device 128 may relay or send the request 214 to computing system 104 in central administrative domain 116, over connection 154. In response to receiving the request 214 from the first user device(s) 156 via the first session processing device 128 in the first administrative domain 124, the computing system 104 may identify a signaling protocol that is used by each of the first administrative domain 124 and the second administrative domain 134 to establish communication sessions. The computing system 104 may determine whether the first administrative domain 124 and the second administrative domain 134 require different signaling protocols to establish communication sessions. Based on a determination that the first administrative domain 124 and the second administrative domain 134 require different signaling protocols to establish communication sessions, the computing system 104 may convert at least one of a first signaling protocol used by the first administrative domain or a second signaling protocol used by the second administrative domain into a common signaling protocol, in some cases, using protocol translation functionality 216. In some examples, each of the first signaling protocol and the second signaling protocol may include one of a SIP, a WebRTC protocol, an XMPP, an SS7 protocol, an MGCP, a Q.931 protocol, a H.323 protocol, or a QSIG protocol, and/or the like.

In examples, in response to receiving a call acceptance 218 from the second user device(s) 162 via the second session processing device 138 in the second administrative domain 134 via connection 154, the computing system 104 may establish an E2E real-time communication session 220 between the first user device(s) 156 in the first administrative domain 124 and the second user device(s) 162 in the second administrative domain 134, using the common signaling protocol. In some cases, the computing system 104 may orchestrate session establishment at the control planes of the first session processing device 128 and the second session processing device 138. In some instances, the computing system 104 may receive session metadata (e.g., call IDs 160 and 166, as well as other information associated with the session, or the like), which may be used to establish the E2E real-time communication session 220. In an example, the session metadata may be appended to the request 214 and/or the call acceptance 218. In another example, the session metadata may be collected, retrieved, or otherwise accessed by the computing system 104 through other channels and/or from other sources. In some examples, the computing system 104 may authenticate each of at least one of the first user device(s) 156 or the first party 158 and at least one of the second user device(s) 162 or the second party 164, using authentication/encryption functionality 230. Subsequently, the computing system 104 may encrypt data and media streams 222 and 224, using authentication/encryption functionality 230, prior to sending from one of the first user device(s) 156 or the second user device(s) 162 to the other of the first user device(s) 156 or the second user device(s) 162 over the E2E real-time communication session 220. In the case that the computing system 104 determines that one or more endpoints and/or any of the portions (also referred to as “legs”) of the E2E real-time communication session 220 cannot be encrypted, the computing system 104 may prevent establishment of the E2E real-time communication session 220, in some cases, by rejecting the request 214.

In some examples, the second user device(s) 162 may include a plurality of second user devices 162 including two or more of a smart phone, a tablet computer, a laptop computer, a desktop computer, or a conferencing telephone, and/or the like, each running one or more of a mobile software application (“app”), a teleconferencing app, a VoIP communications app, or a multimedia communications app, and/or the like. In the case that the computing system 104 determines that user preferences of the second party 164 indicate to ring the plurality of second user devices when receiving call requests, the computing system 104 may fork the request 214 (also referred to as a “call request”) to simultaneously ring each of the plurality of second user devices to turn the plurality of second user devices into a plurality of ringing endpoints, using call forking functionality 232. In response to the request 214 being accepted on one of the plurality of second user devices, the computing system 104 may trigger removal of media streams to the other of the plurality of second user devices to detach other ringing endpoints among the plurality of ringing endpoints. For example, in the case that the second party 164 sets up user preferences to simultaneously ring that user's smart phone, desktop app, and tablet mobile app when a call request is received, the computing system 104 would fork the call request to all three devices (e.g., smart phone, desktop app, and tablet mobile app) when the call request is received. When the second party 164 answers the call request on the tablet mobile app, the computing system 104 triggers removal of media streams to the smart phone and the desktop app to detach the smart phone and the desktop app as ringing endpoints.

In some examples, the computing system 104 may tailor the E2E real-time communication session 220 to the type of endpoint devices that are connected when the E2E real-time communication session 220 is established. For such functionality, for each of the first user device(s) 156 and the second user device(s) 162, the computing system 104 may identify what type of endpoint device that user device is. Based on the type of endpoint device, the computing system 104 may determine features and limitations for that type of endpoint device. The computing system 104 may identify common features between the first user device(s) 156 and the second user device(s) 162. The computing system 104 may identify a most restrictive limitation among the limitations of the first user device(s) 156 and the limitations of the second user device(s) 162. The computing system 104 may provide options for enabling the common features. The computing system 104 may cap features of the E2E real-time communication session 220 to the most restrictive limitation. The computing system 104 may generate and send a message to each of the first user device(s) 156 and the second user device(s) 162 indicating the options for enabling the common features and indicating that the features of the E2E real-time communication session 220 have been capped to the most restrictive limitation. In some cases, the computing system 104 may provide the information regarding the types of endpoint devices, the common features available, the common features selected by one or more parties to the E2E real-time communication session 220, the most restrictive limitation, and the features of the E2E real-time communication session 220 that have been capped to the most restrictive limitation to each of the first session processing device 128 and the second session processing device 138. In this manner, each of the first session processing device 128 and the second session processing device 138 is provided with additional E2E information regarding the E2E real-time communication session 220 being established between the first user device(s) 156 and the second user device(s) 162.

In examples, the computing system 104 may perform dynamic call routing, using dynamic call routing functionality 234. In some cases, dynamic call routing may include the computing system 104 performing the following operations: (a) evaluating user preferences of at least one of the first party 158 or the second party 164 with respect to communication sessions; (b) evaluating network conditions within each of the central administrative domain, the first administrative domain, and the second administrative domain across which the E2E real-time communication session is established (in some cases, using session metrics 226 and 228 as measured or monitored by monitoring system 110, or the like); (c) evaluating a current load on each of the first session processing device 128 and the second session processing device 138 (in some cases, also using session metrics 226 and 228, respectively, as measured or monitored by monitoring system 110, or the like); (d) selecting optimal endpoints and routes (through at least one of the first administrative domain 124, the central administrative domain 116, and/or the second administrative domain 134, or the like) for establishing and maintaining the E2E real-time communication session 220, based on the user preferences of the at least one of the first party 158 or the second party 164 (from operation (a) above), the network conditions within the central administrative domain 116 and the first and second administrative domains 124 and 134 (from operation (b) above), and the current load on each of the first session processing device 128 and the second session processing device 138 (from operation (c) above); and (e) dynamically routing the data and media streams 222 and 224 over the selected optimal endpoints and routes; and/or the like.

In some examples, the PPSP-based communications system enables multimodal operations—including two or more of video call functionality, voice (only) call functionality, text-based communication functionality, and/or multimedia-based communication functionality, and/or the like—as well as multimodal transitioning functionality 236. For multimodal transitioning, in response to receiving a first request to switch from a voice call to a video call during the E2E real-time communication session, the computing system 104 may add a video stream to the E2E real-time communication session. Alternatively, in response to receiving a second request to switch from the video call to the voice call during the E2E real-time communication session, the computing system 104 may remove the video stream from the E2E real-time communication session. In some instances, the PPSP-based communications system may further enable document sharing functionality 238. For document sharing, in response to receiving a third request to share at least one of data files, media files, or documents during the E2E real-time communication session 220, the computing system 104 may add a media stream channel to the E2E real-time communication session 220. Alternatively, in response to receiving a fourth request to end sharing of the at least one of the data files, the media files, or the documents during the E2E real-time communication session 220, the computing system 104 may remove the media stream channel from the E2E real-time communication session 220. In examples, the computing system 104 may perform session management, using session management functionality 240. For session management, the computing system 104 may manage the E2E real-time communication session across control and data planes of the first session processing device 128 in the first administrative domain 124 and the second session processing device 138 in the second administrative domain 134.

In examples, the computing system 104 may perform compliance monitoring, using compliance monitoring functionality 242. For compliance monitoring, the computing system 104 may determine whether features of the E2E real-time communication session 220 comply with each of a first compliance policy to which the first party 158 is under obligation to be held and a second compliance policy to which the second party 164 is under obligation to be held. In examples, the first or second compliance policy may include adherence to regulatory compliance rules, including, but not limited to, the Secure Telephone Identity Revisited (“STIR”) and the Signature-based Handling of Asserted Information Using Tokens (“SHAKEN”) standards or suites of guidelines implemented by the United States Federal Communications Commission (“FCC”). STIR/SHAKEN aim to combat caller ID spoofing and robocalls by requiring telecommunications service providers to ensure that the displayed caller ID accurately reflects the originating number by digitally verifying the authenticity of a caller's identity prior to a call reaching its recipient. In some cases, the first or second compliance policy may include company policies that serve to protect the company and/or its employees, e.g., by requiring communications to be encrypted between parties (whether among internal parties or with external parties). In some instances, the first or second compliance policy may include policies of an educational institution that serve to protect its teaching staff, its administrative staff, its other staff, its students, and the local community members, e.g., by ensuring that personal information (including personally identifiable information (“PII”)) of individuals is not publicly accessible. Examples of PII of an individual include full name, social security number, taxpayer identification number, patient identification number, driver's license number, financial account number, credit card number, passport number, email address, date of birth, telephone number, authentication credentials (e.g., username and password), and/or the like. In some examples, the first or second compliance policy may include policies of a healthcare facility that serve to protect its patients, its medical professionals, its administrative staff, and its other staff. And so on. Based on a determination that the features of the E2E real-time communication session 220 fail to comply with at least one of the first compliance policy or the second compliance policy, the computing system 104 may perform one of: (1) blocking establishment of the E2E real-time communication session 220 (in the case that the E2E real-time communication session 220 has not yet been established); (2) terminating the E2E real-time communication session 220 after it has been established; or (3) sending a message to at least one compliance enforcement entity associated with the corresponding at least one of the first compliance policy or the second compliance policy, the message indicating non-compliance and including details regarding the non-compliance.

In examples, the computing system 104 may monitor, using monitoring system 110, E2E session metrics 226 and 228 across the E2E real-time communication session 220 between the first user device(s) 156 in the first administrative domain 124 and the second user device(s) 162 in the second administrative domain 134, and across the control and data planes of the first session processing device 128 and the second session processing device 138. In some examples, monitoring the E2E session metrics 226 and 228 across the E2E real-time communication session 220 may include the computing system 104 and/or the monitoring system 110 monitoring latency and jitter across the E2E real-time communication session 220, in real-time or near-real-time. As used herein, “real-time monitoring” may refer to monitoring that occurs within about one or two seconds or less from the time that session metrics changes to the time that the session metrics are sensed or monitored, while “near-real-time monitoring” may refer to almost current monitoring that occurs between about three seconds and about one or two minutes from the time that session metrics changes to the time that the session metrics are sensed or monitored. In some cases, in response to determining that the monitored latency and jitter indicate that media quality of media streams 222 or 224 being sent over the E2E real-time communication session 220 has degraded, the computing system 104 may trigger application of media filters to optimize the media streams, using stream optimization functionality 244. In some instances, the computing system 104 may provide each of the first session processing device 128 and the second session processing device 138 with access to the E2E session metrics 226 and 228 and reports generated based on the E2E session metrics 226 and 228.

In some examples, in response to determining that a network issue has disconnected the E2E real-time communication session 220, the computing system may trigger a retry logic function 246 that reconnects the E2E real-time communication session 220 and that causes media streams 222 and 224 to resume transmission over the E2E real-time communication session 220. In examples, the computing system 104 may perform session metrics analysis using session metrics analysis functionality 248. In some cases, when triggered, session metrics analysis may be based on the monitored E2E session metrics 226 and 228 across the E2E real-time communication session 220 to provide information regarding session performance. The computing system 104 may perform other session features 250, including, but not limited to, merging sessions, transcoding media, relaying media, session interconnection, session federation, etc. Table 1 below lists a set of composable functions that provide session features, some of which are described above. The composable functions address various aspects of session management, signaling, and interdependencies across real-time communications (“RTC”) modalities, enabling developers to construct flexible and dynamic call flows.

TABLE 1
List of Composable Functions of the PPSP-based Communications Service

| | |
|---|---|
| Functions | Description |

Session Lifecycle Management

| | |
|---|---|
| Initialize Session | Start a new session with specified parameters (e.g., source, |
| | destination, session type) |
| Terminate Session | Cleanly terminate a session, releasing all associated |
| | resources |
| Pause Session | Temporarily halt a session without terminating it |
| Resume Session | Restart a previously paused session |
| Session Timeout Handler | Define timeout conditions and associated actions for idle or |
| | unresponsive sessions |
| Session State Change | Trigger actions based on predefined state changes in the |
| | session lifecycle |

Signaling Handling

| | |
|---|---|
| Handle Signaling Message | Process incoming signaling messages (e.g., SIP INVITE, |
| | WebRTC offer) |
| Route Signaling | Route signaling messages to the appropriate next hop or |
| | processing function |
| Modify Headers | Add, remove, or modify protocol-specific headers or |
| | metadata |
| Translate Signaling Protocol | Convert signaling messages between protocols (e.g., SIP to |
| | WebRTC) |
| Protocol Adapter | Interface with external signaling protocols dynamically |
| | based on session context |

Session Composition and Features

| | |
|---|---|
| Add Media Stream | Attach a media stream (e.g., audio, video) to an existing |
| | session |
| Remove Media Stream | Detach a media stream from an active session |
| Fork Session | Create multiple branches of a session for parallel processing |
| | (e.g., call forking) |
| Merge Session | Combine multiple session branches into a single stream |
| Transcode Media | Dynamically transcode media between codecs |
| Apply Media Filter | Apply filters to media streams (e.g., noise suppression, echo |
| | cancellation) |
| Media Relay | Relay media streams across networks while maintaining |
| | session integrity |

Interoperability and Extensibility

| | |
|---|---|
| Session Interconnect | Establish interconnections between disparate session |
| | elements (e.g., SBCs, gateways) |
| Session Federation | Enable cross-domain session sharing with identity and policy |
| | enforcement |
| Policy Enforcement | Apply session-level policies such as access control, |
| | bandwidth allocation, or routing rules |
| Session Translation | Provide abstraction and translation between session |
| | modalities (e.g., voice to video). |

State and Context Management

| | |
|---|---|
| Set Session State | Assign a state to a session for context-aware processing |
| Retrieve Session Context | Access context or metadata associated with a session |
| Synchronize State | Synchronize session state across distributed session |
| | processing elements |

Error and Exception Handling

| | |
|---|---|
| Handle Session Error | Define actions to handle session-related errors or anomalies |
| Fallback Handler | Redirect sessions to alternative paths or resources in case of |
| | failure |
| Retry Logic | Implement logic to retry failed session operations |

Event-Driven Processing

| | |
|---|---|
| On Session Event | Trigger specific functions based on session events (e.g., call |
| | answered, participant joined) |
| Session Event Listener | Continuously listen for session events and pass them to |
| | relevant handlers |

Analytics and Monitoring

| | |
|---|---|
| Log Session Activity | Log session events and metadata for auditing or debugging |
| Generate Session Metrics | Create real-time metrics for session performance (e.g., |
| | latency, jitter) |
| Monitor QoS | Continuously monitor Quality of Service (“QoS”) metrics for |
| | active sessions |

Integration with External Systems

| | |
|---|---|
| Integrate With CRM | Synchronize session data with external customer relationship |
| | management (“CRM”) or enterprise systems |
| Trigger External API | Call external application programming interfaces (“APIs”) |
| | based on session activity or state |
| Session Data Export | Export session details and events to external databases or |
| | analytics platforms |

Dynamic Routing and Load Balancing

| | |
|---|---|
| Dynamic Session Routing | Route sessions dynamically based on real-time metrics or |
| | policies |
| Load Balance Sessions | Distribute session processing across multiple elements for |
| | scalability |

Security and Compliance

| | |
|---|---|
| Encrypt Media | Apply encryption to media streams (e.g., Secure Real-Time |
| | Transport Protocol (“SRTP”), Datagram Transport Layer |
| | Security (“DTLS”)) |
| Authenticate Session | Verify session participants using secure authentication |
| | methods |
| Apply Compliance Rules | Ensure sessions comply with regulatory requirements (e.g., |
| | STIR/SHAKEN) |

Turning to FIG. 2C, a first user device(s) 156, which is associated with first party 158 and with first call ID 160, may send a request 252 to establish a communication session among the first user device 156 in the first administrative domain 124, a second user device(s) 162 in second administrative domain 134, and a third user device(s) 168 in third administrative domain 144. In examples, the second user device(s) 162 may be associated with second party 164 and with second call ID 166, while the third user device(s) 168 may be associated with third party 170 and with third call ID 172. In response to receiving the request 252 from the first user device(s) 156, the first session processing device 128 may relay or send the request 252 to computing system 104 in central administrative domain 116, over connection 154. In response to receiving the request 252 from the first user device(s) 156 via the first session processing device 128 in the first administrative domain 124, the computing system 104 may identify a signaling protocol that is used by each of the first administrative domain 124, the second administrative domain 134, and the third administrative domain 144 to establish communication sessions.

The computing system 104 may determine whether the first administrative domain 124, the second administrative domain 134, and the third administrative domain 144 require different signaling protocols to establish communication sessions. Based on a determination that the first administrative domain 124, the second administrative domain 134, and the third administrative domain 144 require different signaling protocols to establish communication sessions, the computing system 104 may convert at least one of a first signaling protocol used by the first administrative domain, a second signaling protocol used by the second administrative domain, or a third signaling protocol used by the third administrative domain into a common signaling protocol, in some cases, using protocol translation functionality 216 (as described above with respect to FIG. 2B). In some examples, each of the first signaling protocol, the second signaling protocol, and the third signaling protocol may include one of a SIP, a WebRTC protocol, an XMPP, an SS7 protocol, an MGCP, a Q.931 protocol, a H.323 protocol, or a QSIG protocol, and/or the like. In examples, in response to receiving a call acceptance 254 from the second user device(s) 162 via the second session processing device 138 in the second administrative domain 134 via connection 154 and a call acceptance 256 from the third user device(s) 168 via the third session processing device 148 in the third administrative domain 144 via connection 154, the computing system 104 may establish an E2E real-time communication session 258 among (or between each of) the first user device(s) 156 in the first administrative domain 124, the second user device(s) 162 in the second administrative domain 134, and the third user device(s) 168 in the third administrative domain 144, using the common signaling protocol. In some instances, the computing system 104 may receive session metadata (e.g., call IDs 160, 166, 172, as well as other information associated with the session, or the like), which may be used to establish the E2E real-time communication session 258. In an example, the session metadata may be appended to the request 252 and/or the call acceptances 254 and 256. In another example, the session metadata may be collected, retrieved, or otherwise accessed by the computing system 104 through other channels and/or from other sources.

In examples, the computing system 104 may monitor, using monitoring system 110, E2E session metrics 266, 268, and 270 across the E2E real-time communication session 258 among (or between each of) the first user device(s) 156 in the first administrative domain 124, the second user device(s) 162 in the second administrative domain 134, and the third user device(s) 168 in the third administrative domain 144, and across the control and data planes of the first session processing device 128, the second session processing device 138, and the third session processing device 148. In some examples, monitoring the E2E session metrics 266, 268, and 270 across the E2E real-time communication session 258 may include the computing system 104 and/or the monitoring system 110 monitoring latency and jitter across the E2E real-time communication session 258, in real-time or near-real-time. In some cases, in response to determining that the monitored latency and jitter indicate that media quality of media streams 260, 262, and/or 264 being sent over the E2E real-time communication session 258 has degraded, the computing system 104 may trigger application of media filters to optimize the media streams, using stream optimization functionality 244 (as described above with respect to FIG. 2B). In some instances, the computing system 104 may provide each of the first session processing device 128, the second session processing device 138, and the third session processing device 148 with access to the E2E session metrics 266, 268, and 270 and reports generated based on the E2E session metrics 266, 268, and 270.

The operations and functionalities of the PPSP-based communication system for handling three party communication sessions (as shown and described with respect to FIG. 2C) (or for four or more party communication sessions) are otherwise similar, if not identical, to the operations and functionalities of the PPSP-based communication system for handling two party communication sessions (as shown and described with respect to FIG. 2B), including the session features 216 and 230-250 of FIG. 2B as well as the composable functions of Table 1 above. Accordingly, the session features 216 and 230-250 and the composable functions, as described above with respect to FIG. 2B are similarly applicable to three or more party communication sessions.

With reference to FIGS. 1 and 2A-2C, the PPSP-based communications system (e.g., PPSP-based communications system 102) provides a language and framework for expressing how real-time communication sessions are processed by the control plane and the data plane of programmable session processing elements (e.g., session processing devices 128, 138, and 148). Unlike packet-focused approaches, the PPSP-based communications system operates at the session level, managing session lifecycle, signaling, state, and interdependencies across multiple modalities (e.g., voice, video, data). The PPSP-based communications system is protocol-independent, enabling abstraction from underlying signaling protocols (e.g., SIP, WebRTC, XMPP, etc.) while ensuring interoperability and extensibility.

In examples, the PPSP-based communications system focuses on session management across control and data planes, while programmatically targeting session processors (e.g., session processing devices 128, 138, and 148, including session controllers, SBCs, signaling engines, etc.) for real-time communication. In some examples, the PPSP-based communications system abstracts the entire session, including signaling, media streams, and metadata. In some instances, the PPSP-based communications system performs various processing actions, including session initiation, negotiation, routing, quality control, termination, and/or state management. Being protocol independent, the PPSP-based communications system decouples session logic from specific signaling protocols (e.g., SIP, WebRTC, XMPP, etc.). In some cases, the PPSP-based communications system performs pipeline operations, using state machines and match-action tables for session lifecycle management and signaling handling. In some instances, the PPSP-based communications system utilizes tables and rules, and, in some cases, defines rules for session routing, QoS, and media handling based on session metadata and signaling parameters. In examples, the PPSP-based communications system may include programmable elements that perform session state management, signaling parsing, media path optimization, and/or real-time metrics collection. Over the data plane, the PPSP-based communications system may manage media streams and session metadata in real-time, and may facilitate codec negotiation, network address translation (“NAT”) traversal, and/or QoS policies. Over the control plane, the PPSP-based communications system may orchestrate session establishment and may update session processing rules dynamically. In some examples, for real-time application, the PPSP-based communications system is designed or configured to manage sessions holistically, ensuring real-time QoS, protocol interworking, and state management.

In some aspects, the PPSP-based communications system provides for protocol independence, by abstracting signaling protocol specifics (e.g., SIP, XMPP, etc.) to enable seamless session processing across various signaling standards. In examples, the PPSP-based communications system enables header parsing that parses signaling messages (e.g., SIP INVITE, SDP attributes) and maps them to session attributes. In some examples, the PPSP-based communications system utilizes Match-Action Tables that match session attributes (e.g., session ID, codec, etc.) and that define actions (e.g., route media, apply QoS, trigger transcoding, etc.). In some instances, the PPSP-based communications system provides rich stateful processing for session lifecycles, as well as tracking session state (e.g., initiated, ongoing, terminated) and dependencies. In some cases, extensibility of the PPSP-based communications system facilitates extensions for new signaling protocols, media types, and application-layer enhancements (e.g., AI-driven session optimization, etc.). In some instances, the PPSP-based communications system adheres to control plane and data plane separation, with the control plane managing signaling and policy enforcement, while the data plane handles media streams and session metadata.

FIGS. 3A-3F (collectively, “FIG. 3”) depict flow diagrams illustrating an example method 300 for implementing PPSP-based communications, in accordance with various embodiments. With reference to FIGS. 3A-3F, the operations of example method 300 may be performed by a PPSP-based communications system (e.g., PPSP-based communications system 102 of FIG. 1, or the like) and/or components thereof (e.g., computing system 104 of FIGS. 1 and 2A-2C, and/or AI system 106 of FIG. 1, or the like). As described above, the computing system may include a programmable protocol-independent session processor that is configured to decouple a session logic of communication sessions from signaling protocols used by the first administrative domain and the second administrative domain, and that is further configured to perform session initiation, session negotiation, session routing, session quality control, session termination, and session state management across multiple domains using different signaling protocols. Method 300 of FIG. 3A either may continue onto FIG. 3B following the circular marker denoted, “A,” or may continue onto FIG. 3C following the circular marker denoted, “B.” Method 300 of FIG. 3C may continue onto FIG. 3B following the circular marker denoted, “A.” Method 300 of FIG. 3F may return onto FIG. 3A following the circular marker denoted, “C.”

In the example method 300 of FIG. 3A, at operation 302, a computing system in a central administrative domain (e.g., central administrative domain 116 of FIGS. 1 and 2A-2C, or the like) may receive, from a first session processing device in a first administrative domain (e.g., first session processing device 128 in first administrative domain 124 of FIGS. 1 and 2A-2C, or the like), a request (e.g., request 214 of FIG. 2B, or the like) to establish a communication session between a first user device (e.g., user device(s) 156 of FIGS. 1 and 2A-2C, or the like) in the first administrative domain and a second user device in a second administrative domain (e.g., second user device(s) 162 in second administrative domain 134 of FIGS. 1 and 2A-2C, or the like). At operation 304, the computing system may identify a signaling protocol that is used by each of the first administrative domain and the second administrative domain to establish communication sessions. At operation 306, the computing system may determine whether the first administrative domain and the second administrative domain require different signaling protocols to establish communication sessions. Based on a determination that the first administrative domain and the second administrative domain use the same signaling protocols to establish communication sessions, method 300 may continue onto the process at operation 308. Based on a determination that the first administrative domain and the second administrative domain require different signaling protocols to establish communication sessions, method 300 may continue onto the process at operation 310. At operation 308, the computing system may establish an E2E real-time communication session using the same signaling protocols used by the first and second administrative domains, assuming that the computing system receives a call acceptance (e.g., call acceptance 218 of FIG. 2B, or the like) from the second user device.

At operation 310, the computing system may convert at least one of a first signaling protocol used by the first administrative domain or a second signaling protocol used by the second administrative domain into a common signaling protocol, in some cases, using protocol translation functionality (e.g., protocol translation functionality 216 of FIG. 2B, or the like). In some examples, each of the first signaling protocol and the second signaling protocol may include one of a SIP, a WebRTC protocol, an XMPP, an SS7 protocol, an MGCP, a Q.931 protocol, a H.323 protocol, or a QSIG protocol, and/or the like. At operation 312, the computing system may establish an E2E real-time communication session (e.g., E2E real-time communication session 220 of FIG. 2B, or the like) between the first user device in the first administrative domain and the second user device in the second administrative domain, using the common signaling protocol, assuming that the computing system receives a call acceptance (e.g., call acceptance 218 of FIG. 2B, or the like) from the second user device. At operation 314, the computing system may manage the E2E real-time communication session across control and data planes of the first session processing device in the first administrative domain and a second session processing device (e.g., second session processing device 138 of FIGS. 1 and 2A-2C, or the like) in the second administrative domain. In some examples, the first session processing device and the second session processing device may each be a programmable session processing device including one of a software switch, a gateway device, an SBC, or a communication platform, and/or the like.

At operation 316, the computing system may authenticate each of at least one of the first user device or a first user (e.g., first party 158 of FIGS. 1, 2B, and 2C, or the like) associated with the first user device and at least one of the second user device or a second user (e.g., second party 164 of FIGS. 1, 2B, and 2C, or the like) associated with the second user device. At operation 318, the computing system may encrypt data and media streams prior to sending from one of the first user device or the second user device to the other of the first user device or the second user device over the E2E real-time communication session. In some examples, the computing system may perform the authentication and encryption processes at operations 316 and 318 using authentication and encryption functionality (e.g., authentication and encryption functionality 230 of FIG. 2B, or the like). Method 300 either may continue onto the process at operation 320 in FIG. 3B following the circular marker denoted, “A,” or may continue onto the process at operation 336 in FIG. 3C following the circular marker denoted, “B.”

At operation 320 in FIG. 3B (following the circular marker denoted, “A,” in FIG. 3A), method 300 may include the computing system monitoring E2E session metrics across the E2E real-time communication session between the first user device and the second user device, and across the control and data planes of the first session processing device and the second session processing device. In some cases, the computing system may monitor the E2E session metrics using a monitoring system (e.g., monitoring system 110 of FIGS. 1 and 2A-2C, or the like). In some examples, monitoring the E2E session metrics across the E2E real-time communication session (at operation 320) may include the computing system and/or the monitoring system monitoring latency and jitter across the E2E real-time communication session, in real-time or near-real-time. In some cases, in response to determining that the monitored latency and jitter indicate that media quality of media streams being sent over the E2E real-time communication session has degraded, the computing system may trigger application of media filters to optimize the media streams (at operation 322), in some cases, using stream optimization functionality (e.g., stream optimization functionality 244 of FIG. 2B, or the like). At operation 324, the computing system may provide each of the first session processing device and the second session processing device with access to the E2E session metrics and reports generated based on the E2E session metrics.

At operation 326, the computing system may receive a termination request from one of the first user device or the second user device. In some cases, in response to receiving the termination request from the one of the first user device or the second user device, the computing system may store detailed logs of the E2E real-time communication session in a datastore (e.g., database(s) 112 of FIG. 1, or the like) (at operation 328), the detailed logs enabling future auditing functions. At operation 330, the computing system may trigger session metrics analysis based on the monitored E2E session metrics across the E2E real-time communication session to provide information regarding session performance. In some cases, session metrics analysis may be performed using session metrics analysis functionality (e.g., session metrics analysis functionality 248 of FIG. 2B, or the like). At operation 332, further in response to receiving the termination request from the one of the first user device or the second user device, the computing system may terminate the E2E real-time communication session. At operation 334, the computing system may cause release of resources that are used to establish and maintain the E2E real-time communication session.

At operation 336 in FIG. 3C (following the circular marker denoted, “B,” in FIG. 3A), method 300 may include the computing system parsing signaling messages (e.g., SIP INVITE, session description protocol (“SDP”) attributes, or the like) that correspond to each of the first signaling protocol and the second signaling protocol into a plurality of communication protocol elements. At operation 338, the computing system may map the plurality of communication protocol elements to session attributes (e.g., session ID, codec, etc.) of the E2E real-time communication session. At operation 340, the computing system may match the session attributes to corresponding one or more actions, using at least one Match-Action Table (which may be stored, e.g., in database(s) 112 of FIG. 1, or the like). At operation 342, the computing system may initiate the corresponding one or more actions in the E2E real-time communication session. In some examples, the corresponding one or more actions may include at least one of routing media streams, routing data streams, applying QoS policies, or triggering transcoding of a first codec media type to a second codec media type for one or more data or media streams, and/or the like. Method 300 may continue onto the process at operation 320 in FIG. 3B following the circular marker denoted, “A.”

With reference to FIG. 3D, managing the E2E real-time communication session across the control and data planes of the first session processing device and the second session processing device (at operation 314) may include at least one of: (a) the computing system causing dynamic updates of session processing rules at the control planes of the first session processing device and the second session processing device (at operation 344); (b) the computing system causing one or more of real-time media stream management or real-time session metadata management at the data planes of the first session processing device and the second session processing device (at operation 346); and/or (c) the computing system facilitating one or more of codec negotiation, NAT traversal, or QoS policies, and/or the like (at operation 348); and/or the like. As used herein, codec negotiation may refer to a process of selecting a codec to use for a call between two (or more) devices. NAT traversal, as used herein, may refer to a method for establishing connections between devices on different networks that use network address translation. Herein, QoS policies may refer to rules that prioritize important network traffic over less important traffic.

Referring to FIG. 3E, converting the at least one of the first signaling protocol or the second signaling protocol into the common signaling protocol (at operation 310) may include (1) the computing system abstracting a first plurality of protocol elements from the first signaling protocol and a second plurality of protocol elements from the second signaling protocol (at operation 350); (2) the computing system identifying a third plurality of protocol elements from one or more of the first plurality of protocol elements, the second plurality of protocol elements, or a repository of protocol elements (which may be a repository that is part of, e.g., database(s) 112 of FIG. 1, or the like) that enable both interoperability and extensibility between the first signaling protocol and the second signaling protocol (at operation 352); and (3) the computing system establishing the common signaling protocol based on the third plurality of protocol elements (at operation 354). Alternatively or additionally, converting the at least one of the first signaling protocol or the second signaling protocol into the common signaling protocol (at operation 310) may include one of: (A) the computing system converting one of the first signaling protocol used by the first administrative domain or the second signaling protocol used by the second administrative domain into the other of the first signaling protocol or the second signaling protocol (at operation 356); or (B) the computing system converting each of the first signaling protocol used by the first administrative domain and the second signaling protocol used by the second administrative domain into a third signaling protocol that is different from each of the first and second signaling protocols (at operation 358).

Turning to FIG. 3F, prior to receiving the request to establish the communication session, the computing system may receive, from the first session processing device, a first subscription request (e.g., subscription request 202 of FIG. 2A, or the like) to subscribe the first administrative domain to a PPSP-based communications service (at operation 360). At operation (362), in response to receiving the first subscription request, the computing system may send a first set of configuration files (e.g., configuration files 204 of FIG. 2A, or the like) to the first session processing device. In examples, the first set of configuration files may cause a configuration change in the first session processing device that enables a secure line of communication between the computing system in the central administrative domain and the first session processing device in the first administrative domain. Method 300 may continue onto the process at operation 302 in FIG. 3A following the circular marker denoted, “C.”

The computing system may also receive, from the second session processing device, a second subscription request (e.g., subscription request 206 of FIG. 2A, or the like) to subscribe the second administrative domain to the PPSP-based communications service (at operation 364). At operation 366, in response to receiving the second subscription request, the computing system may send a second set of configuration files (e.g., configuration files 208 of FIG. 2A, or the like) to the second session processing device. Similar to the first set of configuration files, the second set of configuration files may cause a configuration change in the second session processing device that enables a secure line of communication between the computing system in the central administrative domain and the second session processing device in the second administrative domain. Method 300 may continue onto the process at operation 302 in FIG. 3A following the circular marker denoted, “C.”

FIGS. 4A and 4B (collectively, “FIG. 4”) depict flow diagrams illustrating another example method 400 for implementing PPSP-based communications, in accordance with various embodiments. Referring to FIGS. 4A and 4B, the operations of example method 400 may be performed by a PPSP-based communications system (e.g., PPSP-based communications system 102 of FIG. 1, or the like) and/or components thereof (e.g., computing system 104 of FIGS. 1 and 2A-2C, and/or AI system 106 of FIG. 1, or the like). As described above, the computing system may include a programmable protocol-independent session processor that is configured to decouple a session logic of communication sessions from signaling protocols used by the first administrative domain and the second administrative domain, and that is further configured to perform session initiation, session negotiation, session routing, session quality control, session termination, and session state management across multiple domains using different signaling protocols. Method 400 of FIG. 4A may continue onto FIG. 4B following the circular marker denoted, “A.”

FIG. 4 is similar to FIG. 3, except that, instead of the E2E real-time communication session being requested and subsequently established between two devices in different administrative domains (e.g., the first and second user devices), FIG. 4 is directed to the E2E real-time communication session being requested and subsequently established among three devices in different administrative domains (e.g., the first, second, and third user devices). Accordingly, the processes of method 300 are otherwise applicable to method 400, and the descriptions of the processes of method 300 are similarly applicable to corresponding processes of method 400. Processes of method 300 that are not specifically described with respect to method 400 may also be applicable to method 400 albeit adapted to three devices being connected across the E2E real-time communication session instead of the two devices of method 300. Although two device implementation (as described with respect to method 300 of FIGS. 3A-3F) and three device implementation (as described with respect to method 400 of FIGS. 4A and 4B) are described herein, the various embodiments are not so limited, and any suitable number of devices in any suitable number of different (or same) administrative domains may be connected using the E2E real-time communication session as described herein, albeit adapted for the number of devices connected.

In the example method 400 of FIG. 4A, at operation 405, a computing system in a central administrative domain (e.g., central administrative domain 116 of FIGS. 1 and 2A-2C, or the like) may receive, from a first session processing device in a first administrative domain (e.g., first session processing device 128 in first administrative domain 124 of FIGS. 1 and 2A-2C, or the like), a request (e.g., request 252 of FIG. 2C, or the like) to establish a communication session between a first user device (e.g., user device(s) 156 of FIGS. 1 and 2A-2C, or the like) in the first administrative domain and each of a second user device in a second administrative domain (e.g., second user device(s) 162 in second administrative domain 134 of FIGS. 1 and 2A-2C, or the like) and a third user device in a third administrative domain (e.g., third user device(s) 168 in third administrative domain 144 of FIGS. 1 and 2C, or the like). At operation 410, the computing system may identify a signaling protocol that is used by each of the first administrative domain, the second administrative domain, and the third administrative domain to establish communication sessions. At operation 415, the computing system may determine whether at least two of the first administrative domain, the second administrative domain, and the third administrative domain require different signaling protocols to establish communication sessions. Based on a determination that all of the first administrative domain, the second administrative domain, and the third administrative domain use the same signaling protocols to establish communication sessions, method 400 may continue onto the process at operation 420. Based on a determination that at least two of the first administrative domain, the second administrative domain, and the third administrative domain require different signaling protocols to establish communication sessions, method 400 may continue onto the process at operation 425. At operation 420, the computing system may establish an E2E real-time communication session using the same signaling protocols used by the first, second, and third administrative domains, assuming that the computing system receives call acceptances (e.g., call acceptances 254 and 256 of FIG. 2C, or the like) from the second and third user devices.

At operation 425, the computing system may convert at least one of a first signaling protocol used by the first administrative domain, a second signaling protocol used by the second administrative domain, or a third signaling protocol used by the third administrative domain into a common signaling protocol, in some cases, using protocol translation functionality (e.g., protocol translation functionality 216 of FIG. 2B, or the like). In some examples, each of the first signaling protocol, the second signaling protocol, and the third signaling protocol may include one of a SIP, a WebRTC protocol, an XMPP, an SS7 protocol, an MGCP, a Q.931 protocol, a H.323 protocol, or a QSIG protocol, and/or the like. At operation 430, the computing system may establish an E2E real-time communication session among the first user device in the first administrative domain, the second user device in the second administrative domain, and the third user device in the third administrative domain, using the common signaling protocol, assuming that the computing system receives call acceptances (e.g., call acceptances 254 and 256 of FIG. 2C, or the like) from the second and third user devices. At operation 435, the computing system may manage the E2E real-time communication session (e.g., E2E real-time communication session 220 of FIG. 2C, or the like) across control and data planes of the first session processing device in the first administrative domain, a second session processing device (e.g., second session processing device 138 of FIGS. 1 and 2A-2C, or the like) in the second administrative domain, and a third session processing device (e.g., third session processing device 148 of FIGS. 1, 2A, and 2C, or the like) in the third administrative domain. In some examples, the first session processing device, the second session processing device, and the third session processing device may each be a programmable session processing device including one of a software switch, a gateway device, an SBC, or a communication platform, and/or the like.

At operation 440, the computing system may authenticate each of at least one of the first user device or a first user (e.g., first party 158 of FIGS. 1, 2B, and 2C, or the like) associated with the first user device, at least one of the second user device or a second user (e.g., second party 164 of FIGS. 1, 2B, and 2C, or the like) associated with the second user device, and at least one of the third user device or a third user (e.g., third party 170 of FIGS. 1 and 2C, or the like) associated with the third user device. At operation 445, the computing system may encrypt data and media streams prior to sending from one of the first user device, the second user device, or the third user device to the others of the first user device, the second user device, or the third user device over the E2E real-time communication session. In some examples, the computing system may perform the authentication and encryption processes at operations 316 and 318 using authentication and encryption functionality (e.g., authentication and encryption functionality 230 of FIG. 2B, or the like). Method 400 may continue onto the process at operation 450 in FIG. 4B following the circular marker denoted, “A.”

At operation 450 in FIG. 4B (following the circular marker denoted, “A,” in FIG. 4A), method 400 may include the computing system monitoring E2E session metrics across the E2E real-time communication session among the first user device, the second user device, and the third user device, and across the control and data planes of the first session processing device, the second session processing device, and the third session processing device. In some cases, the computing system may monitor the E2E session metrics using a monitoring system (e.g., monitoring system 110 of FIGS. 1 and 2A-2C, or the like). In some examples, monitoring the E2E session metrics across the E2E real-time communication session (at operation 450) may include the computing system and/or the monitoring system monitoring latency and jitter across the E2E real-time communication session, in real-time or near-real-time. In some cases, in response to determining that the monitored latency and jitter indicate that media quality of media streams being sent over the E2E real-time communication session has degraded, the computing system may trigger application of media filters to optimize the media streams (at operation 455), in some cases, using stream optimization functionality (e.g., stream optimization functionality 244 of FIG. 2B, or the like). At operation 460, the computing system may provide each of the first session processing device, the second session processing device, and the third session processing device with access to the E2E session metrics and reports generated based on the E2E session metrics.

At operation 465, the computing system may receive a termination request from one of the first user device, the second user device, or the third user device. In some cases, in response to receiving the termination request from the one of the first user device, the second user device, or the third user device, the computing system may store detailed logs of the E2E real-time communication session in a datastore (e.g., database(s) 112 of FIG. 1, or the like) (at operation 470), the detailed logs enabling future auditing functions. At operation 475, the computing system may trigger session metrics analysis based on the monitored E2E session metrics across the E2E real-time communication session to provide information regarding session performance. In some cases, session metrics analysis may be performed using session metrics analysis functionality (e.g., session metrics analysis functionality 248 of FIG. 2B, or the like). At operation 480, further in response to receiving the termination request from the one of the first user device, the second user device, or the third user device, the computing system may terminate the E2E real-time communication session. At operation 485, the computing system may cause release of resources that are used to establish and maintain the E2E real-time communication session.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200A-200C of FIGS. 1 and 2A-2C, respectively (or components thereof), such methods may also be implemented using any suitable hardware (or software) implementation. Similarly, while each of the systems, examples, or embodiments 100 and 200A-200C of FIGS. 1 and 2A-2C, respectively (or components thereof), can operate according to the methods 300, 400 (e.g., by executing instructions embodied on a computer readable medium), the systems, examples, or embodiments 100 and 200A-200C of FIGS. 1 and 2A-2C can each also operate according to other modes of operation and/or perform other suitable procedures.

### Exemplary System and Hardware Implementation

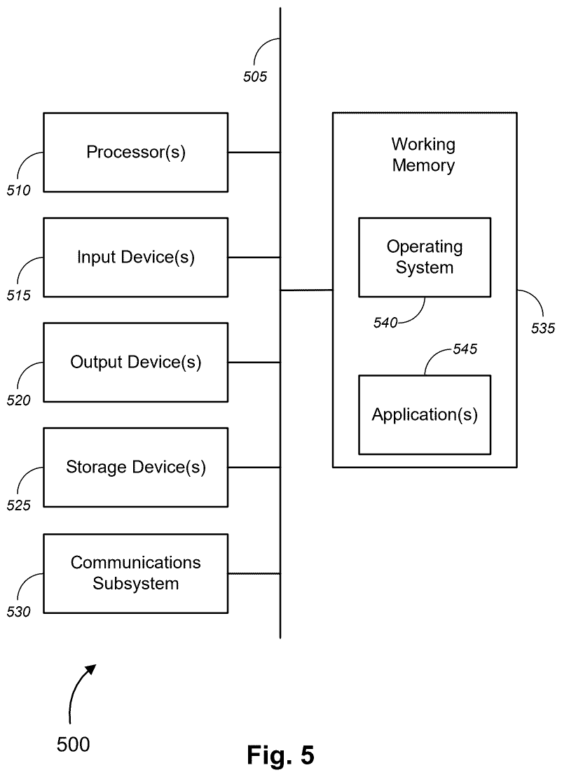

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., PPSP-based communications system 102, computing system 104, AI system 106, monitoring system 110, gateway devices 122, first session processing device 128, second session processing device 138, third session processing device 148, first user device(s) 156 and 156a-156e, second user device(s) 162 and 162a-162e, and third user device(s) 168 and 168a-168e, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., PPSP-based communications system 102, computing system 104, AI system 106, monitoring system 110, gateway devices 122, first session processing device 128, second session processing device 138, third session processing device 148, first user device(s) 156 and 156a-156e, second user device(s) 162 and 162a-162e, and third user device(s) 168 and 168a-168e, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system in a central administrative domain and from a first session processing device in a first administrative domain, a request to establish a communication session between a first user device in the first administrative domain and a second user device in a second administrative domain;
identifying, by the computing system, a signaling protocol that is used by each of the first administrative domain and the second administrative domain to establish communication sessions;
based on a determination that the first administrative domain and the second administrative domain require different signaling protocols to establish communication sessions, performing the following:
converting, by the computing system, at least one of a first signaling protocol used by the first administrative domain or a second signaling protocol used by the second administrative domain into a common signaling protocol;
establishing, by the computing system, an end-to-end (“E2E”) real-time communication session between the first user device in the first administrative domain and the second user device in the second administrative domain, using the common signaling protocol;
managing, by the computing system, the E2E real-time communication session across control and data planes of the first session processing device in the first administrative domain and a second session processing device in the second administrative domain;
monitoring, by the computing system, E2E session metrics across the E2E real-time communication session between the first user device and the second user device, and across the control and data planes of the first session processing device and the second session processing device;
providing, by the computing system, each of the first session processing device and the second session processing device with access to the E2E session metrics and reports generated based on the E2E session metrics; and
in response to receiving a termination request from one of the first user device or the second user device, terminating, by the computing system, the E2E real-time communication session, and causing, by the computing system, release of resources that are used to establish and maintain the E2E real-time communication session.

2. The method of claim 1, wherein the computing system includes a programmable protocol-independent session processor that is configured to decouple a session logic of communication sessions from signaling protocols used by the first administrative domain and the second administrative domain, and that is further configured to perform session initiation, session negotiation, session routing, session quality control, session termination, and session state management across multiple domains using different signaling protocols.

3. The method of claim 1, wherein the first session processing device and the second session processing device are each a programmable session processing device including one of a software switch, a gateway device, a session border controller (“SBC”), or a communication platform.

4. The method of claim 1, wherein each of the first signaling protocol and the second signaling protocol includes one of a session initiation protocol (“SIP”), a web real-time communications (“WebRTC”) protocol, an extensible messaging and presence protocol (“XMPP”), a Signaling System No. 7 (“SS7”) protocol, a media gateway control protocol (“MGCP”), a Q.931 protocol, a H.323 protocol, or a Q-Signaling (“QSIG”) protocol.

5. The method of claim 1, wherein converting the at least one of the first signaling protocol or the second signaling protocol into the common signaling protocol comprises one of:
converting, by the computing system, one of the first signaling protocol used by the first administrative domain or the second signaling protocol used by the second administrative domain into the other of the first signaling protocol or the second signaling protocol; or
converting, by the computing system, each of the first signaling protocol used by the first administrative domain and the second signaling protocol used by the second administrative domain into a third signaling protocol that is different from each of the first and second signaling protocols.

6. The method of claim 1, wherein converting the at least one of the first signaling protocol or the second signaling protocol into the common signaling protocol comprises:
abstracting, by the computing system, a first plurality of protocol elements from the first signaling protocol and a second plurality of protocol elements from the second signaling protocol;
identifying, by the computing system, a third plurality of protocol elements from one or more of the first plurality of protocol elements, the second plurality of protocol elements, or a repository of protocol elements that enable both interoperability and extensibility between the first signaling protocol and the second signaling protocol; and
establishing, by the computing system, the common signaling protocol based on the third plurality of protocol elements.

7. The method of claim 1, wherein managing the E2E real-time communication session across the control and data planes of the first session processing device and the second session processing device comprises at least one of:
causing, by the computing system, dynamic updates of session processing rules at the control planes of the first session processing device and the second session processing device;
causing, by the computing system, one or more of real-time media stream management or real-time session metadata management at the data planes of the first session processing device and the second session processing device; or
facilitating, by the computing system, one or more of coder/decoder (“codec”) negotiation, network address translation (“NAT”) traversal, or quality of service (“QoS”) policies.

8. The method of claim 1, further comprising:
parsing, by the computing system, signaling messages that correspond to each of the first signaling protocol and the second signaling protocol into a plurality of communication protocol elements;
mapping, by the computing system, the plurality of communication protocol elements to session attributes of the E2E real-time communication session;
matching, by the computing system, the session attributes to corresponding one or more actions, using at least one Match-Action Table; and
initiating, by the computing system, the corresponding one or more actions in the E2E real-time communication session, the corresponding one or more actions including at least one of routing media streams, routing data streams, applying QoS policies, or triggering transcoding of a first codec media type to a second codec media type for one or more data or media streams.

9. The method of claim 1, further comprising:
authenticating, by the computing system, each of at least one of the first user device or a first user associated with the first user device and at least one of the second user device or a second user associated with the second user device; and
encrypting, by the computing system, data and media streams prior to sending from one of the first user device or the second user device to the other of the first user device or the second user device over the E2E real-time communication session.

10. The method of claim 9, further comprising:
performing dynamic call routing by:
evaluating, by the computing system, user preferences of at least one of the first user or the second user with respect to communication sessions;
evaluating, by the computing system, network conditions within each of the central administrative domain, the first administrative domain, and the second administrative domain across which the E2E real-time communication session is established;
evaluating, by the computing system, a current load on each of the first session processing device and the second session processing device;
selecting, by the computing system, optimal endpoints and routes for establishing and maintaining the E2E real-time communication session, based on the user preferences of the at least one of the first user or the second user, the network conditions within the central administrative domain and the first and second administrative domains, and the current load on each of the first session processing device and the second session processing device; and
dynamically routing, by the computing system, the data and media streams over the selected optimal endpoints and routes.

11. The method of claim 1, wherein the second user device includes a plurality of second user devices including two or more of a smart phone, a tablet computer, a laptop computer, a desktop computer, or a conferencing telephone each running one or more of a mobile software application (“app”), a teleconferencing app, a voice over Internet Protocol (“VoIP”) communications app, or a multimedia communications app, wherein the method further comprises:
determining, by the computing system, that user preferences of a second user associated with the second user device indicate to ring the plurality of second user devices when receiving call requests;
forking, by the computing system, a call request to simultaneously ring each of the plurality of second user devices to turn the plurality of second user devices into a plurality of ringing endpoints; and
in response to the call request being accepted on one of the plurality of second user devices, triggering, by the computing system, removal of media streams to the other of the plurality of second user devices to detach other ringing endpoints among the plurality of ringing endpoints.

12. The method of claim 1, further comprising:
for each of the first user device and the second user device,
identifying, by the computing system, what type of endpoint device that user device is;
based on the type of endpoint device, determining, by the computing system, features and limitations for that type of endpoint device;
identifying, by the computing system, common features between the first user device and the second user device;
identifying, by the computing system, a most restrictive limitation among the limitations of the first user device and the limitations of the second user device;
providing, by the computing system, options for enabling the common features;
capping, by the computing system, features of the E2E real-time communication session to the most restrictive limitation; and
generating and sending, by the computing system, a message to each of the first user device and the second user device indicating the options for enabling the common features and indicating that the features of the E2E real-time communication session have been capped to the most restrictive limitation.

13. The method of claim 1, further comprising one of:
in response to receiving a first request to switch from a voice call to a video call during the E2E real-time communication session, adding, by the computing system, a video stream to the E2E real-time communication session;
in response to receiving a second request to switch from the video call to the voice call during the E2E real-time communication session, removing, by the computing system, the video stream from the E2E real-time communication session;
in response to receiving a third request to share at least one of data files, media files, or documents during the E2E real-time communication session, adding, by the computing system, a media stream channel to the E2E real-time communication session; or
in response to receiving a fourth request to end sharing of the at least one of the data files, the media files, or the documents during the E2E real-time communication session, removing, by the computing system, the media stream channel from the E2E real-time communication session.

14. The method of claim 1, wherein monitoring the E2E session metrics across the E2E real-time communication session includes monitoring, by the computing system, latency and jitter across the E2E real-time communication session, in real-time or near-real-time, wherein the method further comprises:
in response to determining that the monitored latency and jitter indicate that media quality of media streams being sent over the E2E real-time communication session has degraded, triggering, by the computing system, application of media filters to optimize the media streams.

15. The method of claim 1, further comprising:
in response to determining that a network issue has disconnected the E2E real-time communication session, triggering, by the computing system, a retry logic function that reconnects the E2E real-time communication session and that causes media streams to resume transmission over the E2E real-time communication session.

16. The method of claim 1, further comprising:
further in response to receiving the termination request,
storing, by the computing system, detailed logs of the E2E real-time communication session in a datastore, the detailed logs enabling future auditing functions; and
triggering, by the computing system, session metrics analysis based on the monitored E2E session metrics across the E2E real-time communication session to provide information regarding session performance.

17. The method of claim 1, further comprising:
prior to receiving the request to establish the communication session,
receiving, by the computing system and from the first session processing device, a first subscription request to subscribe the first administrative domain to a programmable protocol-independent session processor (“PPSP”)-based communications service;
in response to receiving the first subscription request, sending, by the computing system, a first set of configuration files to the first session processing device, the first set of configuration files causing a configuration change in the first session processing device that enables a secure line of communication between the computing system in the central administrative domain and the first session processing device in the first administrative domain;
receiving, by the computing system and from the second session processing device, a second subscription request to subscribe the second administrative domain to the PPSP-based communications service; and
in response to receiving the second subscription request, sending, by the computing system, a second set of configuration files to the second session processing device, the second set of configuration files causing a configuration change in the second session processing device that enables a secure line of communication between the computing system in the central administrative domain and the second session processing device in the second administrative domain.

18. The method of claim 1, further comprising:
determining, by the computing system, whether features of the E2E real-time communication session comply with each of a first compliance policy to which a first user associated with the first user device is under obligation to be held and a second compliance policy to which a second user associated with the second user device is under obligation to be held;
based on a determination that the features of the E2E real-time communication session fail to comply with at least one of the first compliance policy or the second compliance policy, performing one of:
blocking, by the computing system, establishment of the E2E real-time communication session;
terminating, by the computing system, the E2E real-time communication session after it has been established; or
sending, by the computing system, a message to at least one compliance enforcement entity associated with the corresponding at least one of the first compliance policy or the second compliance policy, the message indicating non-compliance.

19. A programmable protocol-independent session processor (“PPSP”)-based communications system, comprising:
a computing system in a central administrative domain; and
memory coupled to the computing system, the memory comprising computer executable instructions that, when executed by the computing system, causes the PPSP-based communications system to perform operations comprising:
receiving, from a first session processing device in a first administrative domain, a request to establish a communication session between a first user device in the first administrative domain and a second user device in a second administrative domain;
identifying a signaling protocol that is used by each of the first administrative domain and the second administrative domain to establish communication sessions;
based on a determination that the first administrative domain and the second administrative domain require different signaling protocols to establish communication sessions, performing the following:
converting at least one of a first signaling protocol used by the first administrative domain or a second signaling protocol used by the second administrative domain into a common signaling protocol;
establishing an end-to-end (“E2E”) real-time communication session between the first user device in the first administrative domain and the second user device in the second administrative domain, using the common signaling protocol;
managing the E2E real-time communication session across control and data planes of the first session processing device in the first administrative domain and a second session processing device in the second administrative domain;
monitoring E2E session metrics across the E2E real-time communication session between the first user device and the second user device, and across the control and data planes of the first session processing device and the second session processing device;
providing each of the first session processing device and the second session processing device with access to the E2E session metrics and reports generated based on the E2E session metrics; and
in response to receiving a termination request from one of the first user device or the second user device, terminating the E2E real-time communication session, and causing release of resources that are used to establish and maintain the E2E real-time communication session.

20. A method, comprising:
receiving, by a computing system in a central administrative domain and from a first session processing device in a first administrative domain, a request to establish a communication session between a first user device in the first administrative domain and each of a second user device in a second administrative domain and a third user device in a third administrative domain;
identifying, by the computing system, a signaling protocol that is used by each of the first administrative domain, the second administrative domain, and the third administrative domain to establish communication sessions;
based on a determination that at least two of the first administrative domain, the second administrative domain, and the third administrative domain require different signaling protocols to establish communication sessions, performing the following:
converting, by the computing system, at least one of a first signaling protocol used by the first administrative domain, a second signaling protocol used by the second administrative domain, or a third signaling protocol used by the third administrative domain into a common signaling protocol;
establishing, by the computing system, an end-to-end (“E2E”) real-time communication session among the first user device in the first administrative domain, the second user device in the second administrative domain, and the third user device in the third administrative domain, using the common signaling protocol;
managing, by the computing system, the E2E real-time communication session across control and data planes of the first session processing device in the first administrative domain, a second session processing device in the second administrative domain, and a third session processing device in the third administrative domain;
monitoring, by the computing system, E2E session metrics across the E2E real-time communication session among the first user device, the second user device, and the third user device, and across the control and data planes of the first session processing device, the second session processing device, and the third session processing device;
providing, by the computing system, each of the first session processing device, the second session processing device, and the third session processing device with access to the E2E session metrics and reports generated based on the E2E session metrics; and
in response to receiving a termination request from one of the first user device, the second user device, or the third user device, terminating, by the computing system, the E2E real-time communication session, and causing, by the computing system, release of resources that are used to establish and maintain the E2E real-time communication session.
